(19) United States
(12) Patent Application Publication
(10) Pub. No.: US 2025/0053000 A1
(43) Pub. Date: Feb. 13, 2025

(54) PATTERN ELECTRODE STRUCTURE FOR ELECTROWETTING DEVICE

(71) Applicants: Hyundai Motor Company, Seoul (KR); Kia Corporation, Seoul (KR); SL Corporation, Daegu (KR)

(72) Inventors: Kwang-Joon Han, Seongnam-si (KR); Yu-Bin Jeon, Busan (KR); Byung-Kyu Cho, Hwaseong-si (KR); Sung-Hun Han, Gyeongsan-si (KR); Hong-Jun Cha, Gyeongsan-si (KR); Young-Ern Jung, Suseong-gu (KR)

(21) Appl. No.: 18/504,765

(22) Filed: Nov. 8, 2023

(30) Foreign Application Priority Data
Aug. 8, 2023 (KR) 10-2023-0103237

(51) Int. Cl. G02B 27/00

(52) U.S. Cl. CPC G02B 27/0006; G02B 2207/115

(57) ABSTRACT

An embodiment pattern electrode structure for an electrowetting device includes a first branch electrode disposed in a direction perpendicular to any plane that is perpendicular to a plane defined by the pattern electrode structure and a basal pattern electrode disposed in an area above an upper end of the first branch electrode and connected to an electrode connection portion configured to receive a voltage, wherein an interval between the first branch electrode and the basal pattern electrode is equal to or larger than a diameter of a droplet to be removed.

### CROSS-REFERENCE TO RELATED APPLICATIONS

This application claims the benefit of Korean Patent Application No. 10-2023-0103237, filed on Aug. 8, 2023, which application is hereby incorporated herein by reference.

### TECHNICAL FIELD

The present disclosure relates to an electrode structure for an electrowetting device.

### BACKGROUND

An electrowetting phenomenon refers to a phenomenon in which a contact angle between a solid and an electrolyte is changed by a potential difference between the solid and the electrolyte.

The use of this phenomenon may control surface tension of a droplet placed on an electrode coated with an insulator, thereby controlling deformation/movement of a micro-fluid of a micro-liter (μl) unit or less.

In addition, a weight of an application product may be reduced because a separate external driver is not required to operate the application product. Electric power consumption is low and a response speed is high because a flow of electric current is restricted by the insulator applied onto the electrode. Therefore, the electrowetting phenomenon is receiving great attention in various industrial fields.

Examples of the use of electrowetting in the various industries include next-generation electronic devices such as lab-on-a-chip, fluid lenses, and displays that operate in different ways from the related art.

In addition, an electrowetting apparatus may be used to move, deform, and remove a droplet formed on a glass. Therefore, the electrowetting apparatus may be mounted on a windshield, a side mirror, a camera, or the like of a vehicle to remove rainwater and dewdrops.

The above information disclosed in the related art is only for enhancement of understanding of the background of embodiments of the present disclosure and therefore it may contain information that does not form the related art that is already known to a person of ordinary skill in the art.

### SUMMARY

The present disclosure relates to an electrode structure for an electrowetting device. Particular embodiments relate to an electrode structure to which a pattern structure using an electrowetting phenomenon is applied.

Accordingly, an embodiment of the present disclosure provides a pattern electrode structure for an electrowetting device, which is capable of more efficiently exhibiting self-cleaning performance by preventing a droplet from stagnating without falling at an upper end of a pattern in a structure that uses a vertical pattern.

As a preferred embodiment, a pattern electrode structure for an electrowetting device is laminated between a base material and a dielectric layer of the electrowetting device and includes first branch electrodes formed in a direction perpendicular to any plane perpendicular to a plane defined by the pattern electrode structure and a basal pattern electrode formed in an area above upper ends of the first branch electrodes and connected to an electrode connection portion configured to receive a voltage, in which an interval between the first branch electrode and the basal pattern electrode is equal to or larger than a diameter of a droplet to be removed.

More specifically, the interval between the first branch electrode and the basal pattern electrode may be equal to or larger than 1.93 mm.

In this case, the first branch electrode and the basal pattern electrode may have different polarities.

Further, the pattern electrode structure may further include second branch electrodes formed alternately with the first branch electrodes in a width direction of the pattern electrode structure and being different in polarities from the first branch electrodes.

Meanwhile, the upper end of the first branch electrode may be formed as a concave portion.

Alternatively, the upper end of the first branch electrode may be formed as a convex portion.

Alternatively, the upper end of the first branch electrode may include a cutting-edge portion.

Meanwhile, a dummy pattern may be formed in a space between the first branch electrode and the basal pattern electrode.

In the electrowetting glass, when a droplet stays in a particular narrow space and oscillates in place or moves repeatedly, electric charges and ions are moved in the droplet by a periodic change in voltage, and the electric charges and ions are concentrated at a particular position, which causes a burnout because of an excessive yield voltage of the dielectric layer on the glass surface.

However, according to embodiments of the present disclosure, the droplet may be guided to the region where a low periodic voltage or no periodic voltage is applied, thereby preventing a burnout of the dielectric layer.

Therefore, according to embodiments of the present disclosure, it is possible to rapidly improve an operation lifespan of the electrowetting glass.

### BRIEF DESCRIPTION OF THE DRAWINGS

FIGS. 1 to 3 are views for explaining a general electrowetting device.

FIG. 4 is a view illustrating a pattern structure of the electrowetting device.

FIGS. 5 to 11 are views for explaining a limitation of a technology according to a pattern structure in the related art.

FIG. 12 is a view illustrating a part of a pattern structure of an electrowetting device of embodiments of the present disclosure.

FIG. 13 is a view illustrating the entire pattern structure of the electrowetting device of embodiments of the present disclosure.

FIGS. 14 and 15 are views illustrating experimental results obtained from the pattern structure of the electrowetting device of embodiments of the present disclosure.

FIG. 16 is a view illustrating specifications of the pattern structure of the electrowetting device of embodiments of the present disclosure.

FIGS. 17 to 19 are views illustrating application examples in accordance with pattern shapes.

FIG. 20 is a view illustrating an additional application example of the pattern structure of the electrowetting device of embodiments of the present disclosure.

FIG. 21 is a view for explaining an effect of the pattern structure of the electrowetting device of embodiments of the present disclosure.

### DETAILED DESCRIPTION OF ILLUSTRATIVE EMBODIMENTS

Hereinafter, embodiments of the present disclosure will be described in detail with reference to the exemplary accompanying drawings, and since these embodiments, as examples, may be implemented in various different forms by those skilled in the art to which the present disclosure pertains, they are not limited to the embodiments described herein.

In order to sufficiently understand embodiments of the present disclosure, advantages in operation of embodiments of the present disclosure, and the object achievable by carrying out embodiments of the present disclosure, reference needs to be made to the accompanying drawings for illustrating exemplary embodiments of the present disclosure and contents disclosed in the accompanying drawings.

Further, in the description of embodiments of the present disclosure, the repetitive descriptions of publicly known related technologies will be reduced or omitted when it is determined that the descriptions may unnecessarily obscure the subject matter of the embodiments of the present disclosure.

Embodiments of the present disclosure relate to a self-cleaning technology using the electrowetting phenomenon.

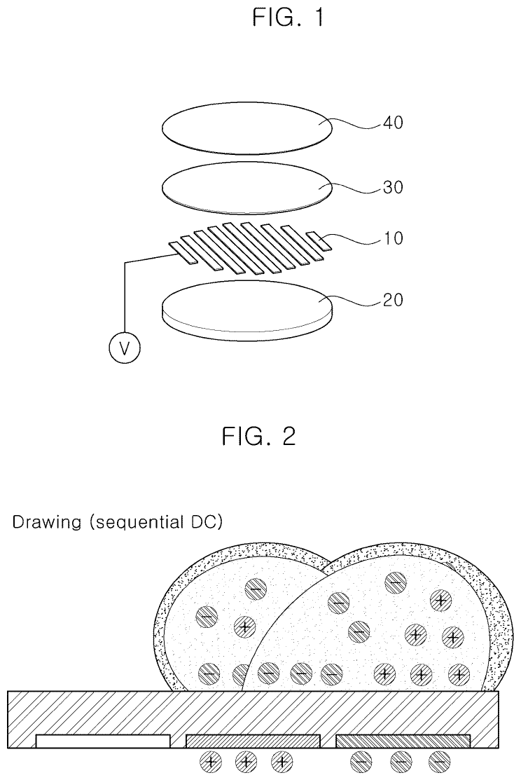

FIG. 1 illustrates a basic electrowetting self-cleaning apparatus in which an electrode layer 10, a dielectric layer 30, and a water-repellent layer 40 are laminated on a glass 20 which is a base material.

The type of base material 20 is not limited, but a transparent glass may be used so that the base material 20 is mounted on a product such as a camera that transmits visible rays.

The electrode layer 10 is a transparent electrode pattern layer and needs to be positioned at a lower end of the dielectric layer, and the performance of the electrode layer 10 is improved as electrical conductivity increases.

The electrode layer 10 need not be necessarily transparent, but the transparent base material 20 needs to be used so that the electrode layer 10 is mounted on the product that transmits visible rays. As representative materials, oxide-based ITO, polymer-based PEDOT:PSS, oxide-polymer composites (FTO), and the like may be used.

The performance may be improved as the dielectric layer 30 has a high dielectric constant and a small thickness. The durability and lifespan are improved as the dielectric layer 30 has high dielectric breakdown strength and a small amount of defects. A deviation in performance and durability decreases as the dielectric layer 30 becomes more uniform, more homogeneous, and more continuous.

The dielectric layer 30 may be configured as a single layer or a multi-layer. As representative materials, oxide/nitride-based materials, such as SiO₂, TiO₂, Al₂O₃, CeO₂, HfO₂, ZrO₂, ZnO, SiON, and Si₃N₄, and polymer-based materials, such as Parylene-C, a cyclic olefin polymer (COP), and polymethylmethacrylate (PMMA), may be used. As deposition methods, wet processes (spray, spin-coating, ink-jet, etc.) and dry processes (E-beam, sputtering, CVD, etc.) may be used.

The water-repellent layer 40 is not an essential element and may be omitted if an outermost peripheral layer of the dielectric layer has a sufficiently large contact angle.

A fluorine compound is used as a representative material, and a coating process is performed by a method such as E-beam spin coating.

When a voltage is applied to the transparent electrode on the glass surface of the electrowetting device, a contact angle of a droplet disposed at the periphery of the electrode is changed.

The droplet disposed at the periphery of the electrode may move in response to a change in polarities of the voltage applied to the electrode or oscillate in response to a change in magnitudes of the voltage.

According to the Lippmann-Young equation, the change in contact angle is large when the following three conditions are met:
(1) Dielectric coating material with high dielectric constant and small thickness;
   (2) Hydrophobic coating material with low interfacial tension (=large contact angle); and
(3) High applied voltage.

The mobility of the droplet on the surface of the electrowetting device varies depending on a frequency and/or magnitude of the applied voltage.

That is, in case that direct current voltages with different polarities are applied to two adjacent electrodes, the droplet is drawn by an attractive force between the electrodes, which have polarities opposite to the polarity of the droplet, as illustrated in FIG. 2, such that the droplet moves.

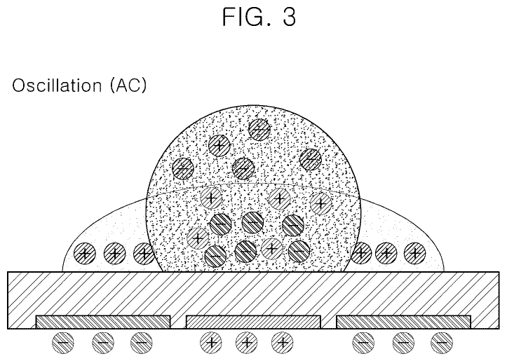

Further, in case that a half-wave rectified current with a phase difference of 180 degrees is continuously applied to the two adjacent electrodes, the droplet is repeatedly contracted and expanded in opposite polarity directions. Therefore, as illustrated in FIG. 3, oscillation occurs, and an adhesion force to a bottom surface decreases.

That is, when an external force is applied to the droplet, the droplet may easily move in a direction of the external force (Decrease in Adhesion Force+Gravity=Fall).

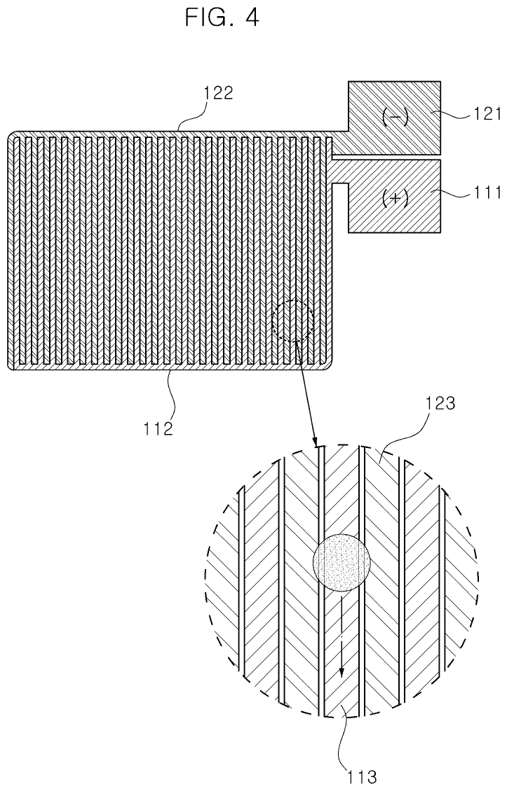

FIG. 4 illustrates an example of an electrode pattern structure. The electrode pattern structure includes a first electrode part and a second electrode part. The first electrode part includes a first electrode connection portion 11, a first basal pattern electrode 112, and a first branch electrode 113. The second electrode part includes a second electrode connection portion 121, a second basal pattern electrode 122, and a second branch electrode 123.

In general, by a method of inducing oscillation by applying an alternating current (AC), a droplet on an electrowetting type surface moves in a length direction of a branch electrode by being affected by gravity.

Therefore, a vertical pattern, which may minimize a fall distance and time, is often employed. However, in the case of a structure that uses a comb-shaped vertical pattern while applying an AC voltage, droplets may stagnate while spanning the electrodes at an upper end of the pattern.

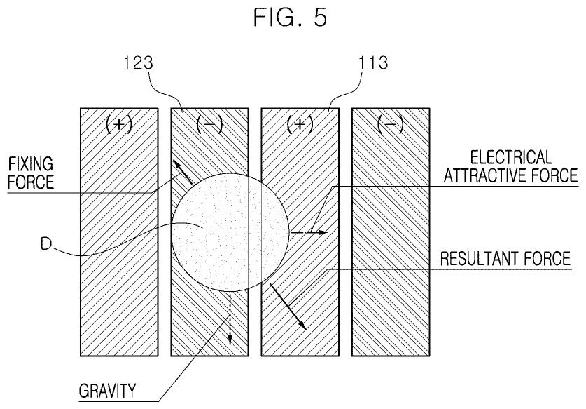

As discussed above, FIG. 4 is a view illustrating a pattern structure of an electrowetting device, and FIGS. 5 to 10 are views for explaining a limitation of a technology according to a pattern structure in the related art.

Embodiments of the present disclosure can prevent a droplet from stagnating without falling at an upper end of a vertical pattern in a structure that uses the vertical pattern.

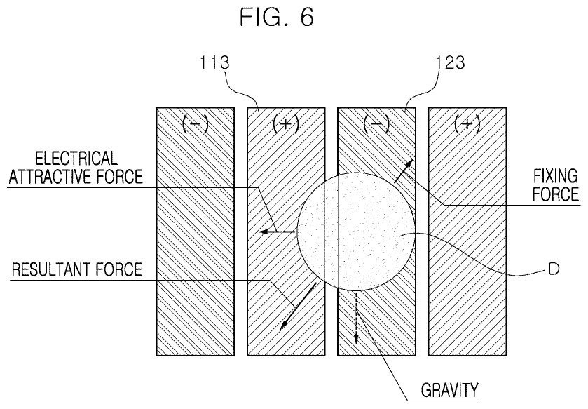

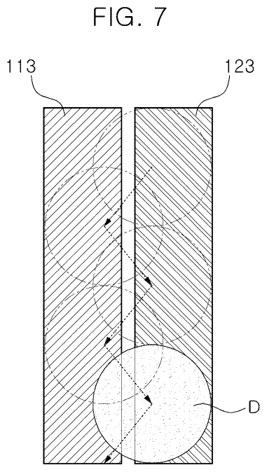

FIGS. 5 to 7 illustrate a case in which a size of a droplet D spans two or fewer electrodes. FIGS. 5 and 6 illustrate that the droplet D spans the first branch electrode 113 and the second branch electrode 123, and an equilibrium relationship between forces is illustrated. FIG. 7 illustrates a motion of the actual droplet D when an alternating current voltage is applied in this situation.

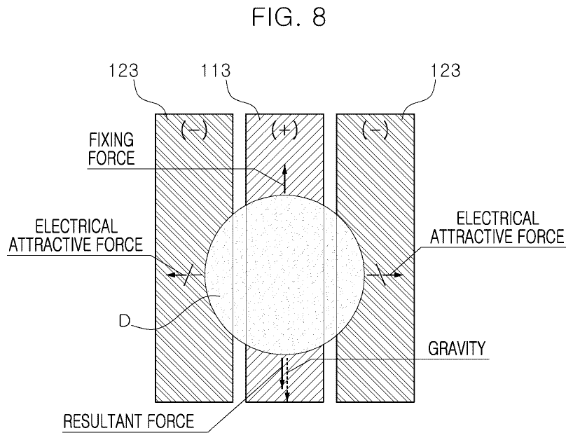

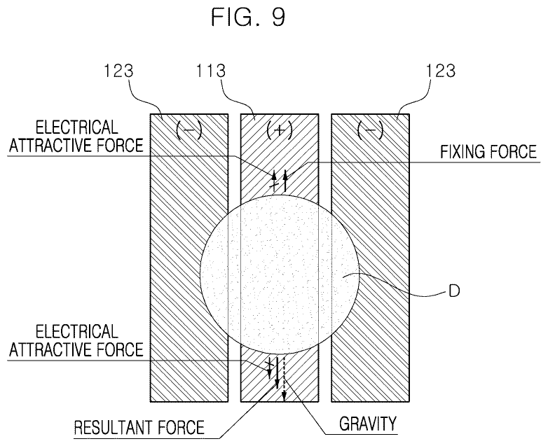

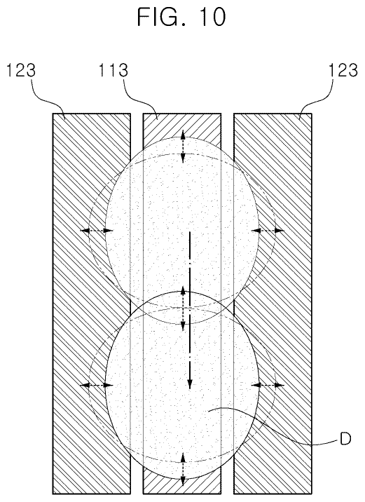

FIGS. 8 to 10 illustrate a case in which a size of the droplet D spans three or more electrodes. FIGS. 8 and 9 illustrate that the droplet D spans the first branch electrode 113 and the second branch electrodes 123 disposed at two opposite sides of the first branch electrode, and an equilibrium relationship between forces is illustrated. FIG. 10 illustrates a motion of the actual droplet D when an alternating current voltage is applied in this situation.

In case that the droplet stays at a particular position over a long period of time without moving as described above, a high potential difference is applied between the droplet and a drive electrode disposed below an insulation layer over a long period of time, and an insulation breakdown of the insulation layer may occur.

The insulation breakdown occurs after occurrence of soot and leads to growth of separation of the insulation layer and overall separation.

An insulation layer with high dielectric breakdown strength may be applied. However, because the dielectric breakdown strength and a dielectric constant are inversely proportional to each other, cleaning performance may significantly deteriorate as the dielectric constant decreases.

Therefore, it is advantageous to prevent the droplet from being stuck at a particular position over a long period of time.

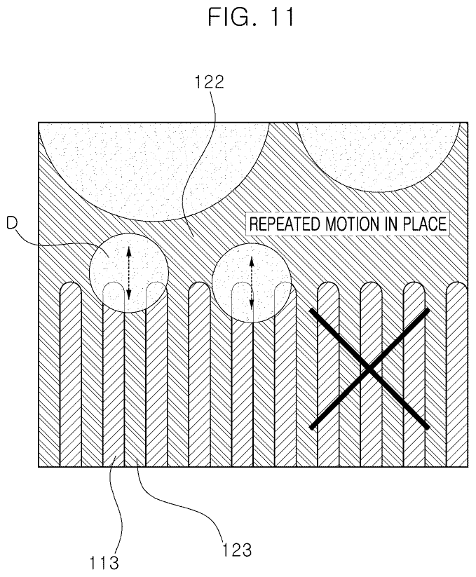

FIG. 11 illustrates a situation in which the droplet is stuck without moving.

FIG. 11 illustrates a situation in which the droplet D is stuck between the first branch electrode 113 and the second basal pattern electrode 122 at the upper end of the first branch electrode 113 and repeatedly moves in place at a fixed position. The right side of FIG. 11 illustrates a part of the droplet that is positioned on the second basal pattern electrode 122 but departs from a visual field of a camera.

When the droplet is stuck without moving as described above, a burnout of a dielectric layer may occur.

That is, when an alternating current voltage is applied in this situation, the droplet, which is moved downward toward the first branch electrode 113 by an electrical attractive force, is moved upward by an electrical attractive force toward the second basal pattern electrode 122 by polarity switching. For this reason, the droplet repeatedly moves and oscillates in a narrow space, and a flow of electric charges and ions in the droplet is concentrated in the narrow space, which causes damage to the dielectric layer.

Embodiments of the present disclosure can prevent the droplet from being stuck at the upper end of the branch electrode as described above.

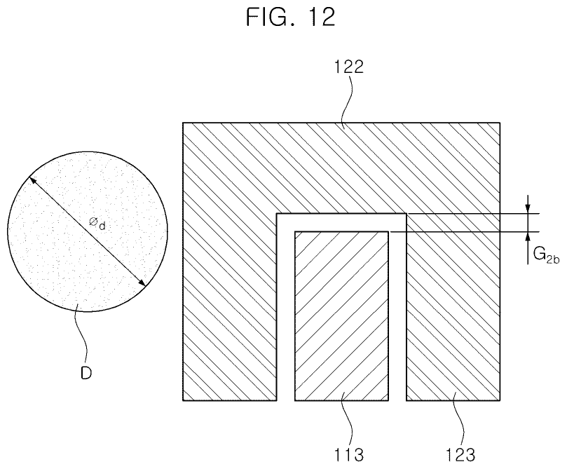

FIG. 12 is a view illustrating a part of a pattern structure of an electrowetting device of embodiments of the present disclosure.

Hereinafter, a pattern electrode structure for an electrowetting device according to an embodiment of the present disclosure will be described with reference to FIG. 12.

As illustrated in FIG. 1, in an electrowetting self-cleaning device of an embodiment of the present disclosure, the electrode layer 10, the dielectric layer 30, and the water-repellent layer 40 are laminated on the glass 20. The water-repellent layer 40 may be a hydrophobic coating layer.

As illustrated in FIG. 4, a pattern structure of the electrowetting device of an embodiment of the present disclosure includes a first electrode part and a second electrode part. The first electrode part includes the first electrode connection portion 111, the first basal pattern electrode 112, and the first branch electrodes 113. The second electrode part includes the second electrode connection portion 121, the second basal pattern electrode 122, and the second branch electrodes 123.

The illustrated pattern structure may have a quadrangular shape, as a whole, but may also have a circular or elliptical shape, as a whole. That is, the overall shape is irrelevant to the subject matter of the embodiments of the present disclosure.

Further, the pattern electrode structure of embodiments of the present disclosure performs self-cleaning by oscillating and dropping droplets on the electrode by receiving an alternating current voltage. A plane defined by the entire structure needs to be a plane perpendicular to a horizontal plane or needs to be a plane inclined at a predetermined angle.

The first electrode connection portion 111 and the second electrode connection portion 121 are connected to a power source to receive a voltage. The first basal pattern electrode 112 and the second basal pattern electrode 122 are respectively connected to the first electrode connection portion 11 and the second electrode connection portion 121 and define an outer periphery of the entire pattern electrode structure. That is, a predetermined region of the outer periphery is defined by the first basal pattern electrode 112, and the remaining region of the outer periphery is defined by the second basal pattern electrode 122.

The first branch electrodes 113 and the second branch electrodes 123 respectively branch off from the first basal pattern electrode 112 and the second basal pattern electrode 122 and are disposed on the electrode structure in one direction. One direction is defined as a direction perpendicular to any plane perpendicular to the electrode structure.

Further, the first branch electrodes 113 and the second branch electrodes 123 are arranged alternately in a width direction.

FIG. 12 illustrates a part of the pattern electrode structure of an embodiment of the present disclosure and illustrates a part including an upper end of the branch electrode and the basal pattern electrode arranged on an upper portion of the pattern electrode structure. In embodiments of the present disclosure, the disposition of the electrode pattern is used to prevent a burnout of the dielectric layer on the upper portion of the glass of the electrowetting device.

In this case, an interval between the first branch electrode 113 and the second basal pattern electrode 122 is indicated by G_{2b}, and a diameter of the droplet D is indicated by (Da.

Because the second basal pattern electrode and the first branch electrode pattern of the electrode pattern in the related art are adjacent to each other in a space defined by the interval G_{2b}, the droplet D may span the second basal electrode and the first branch electrode pattern, which causes the droplet to be stuck.

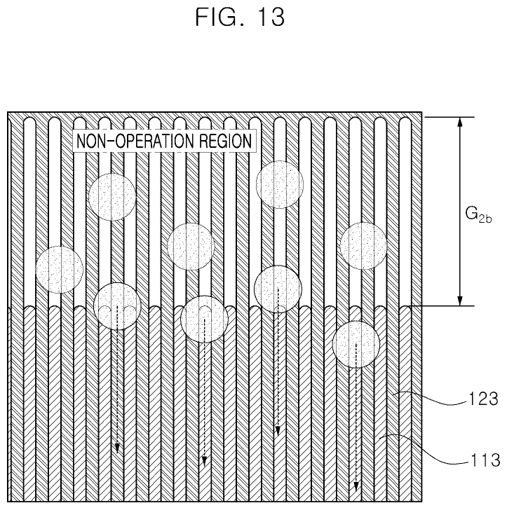

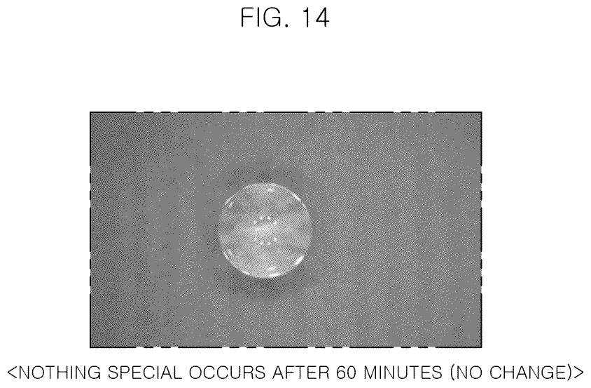

In embodiments of the present disclosure, as illustrated in FIG. 13, the interval G_{2b} is designed to be larger than that in the related art so that the droplet cannot exist between the pattern of the second basal pattern electrode 122 and the pattern of the first branch electrode 113. As a result, as illustrated in FIG. 14, it can be ascertained that a change does not occur during an experiment in which a droplet of 10 is used, and a voltage of 100 Vᵣₘₛ and 100 Hz is applied.

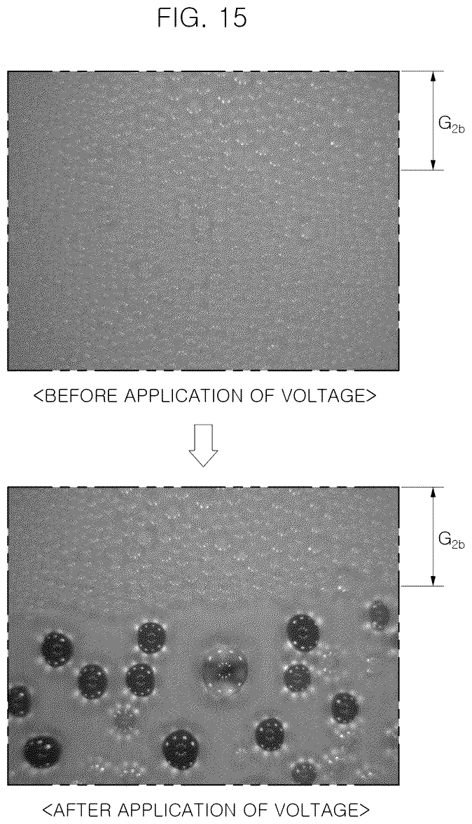

That is, as illustrated in FIG. 15, it can be ascertained that droplets positioned in a spacing region G_{2b} do not oscillate or move downward, and thus a burnout caused by an insulation breakdown does not occur.

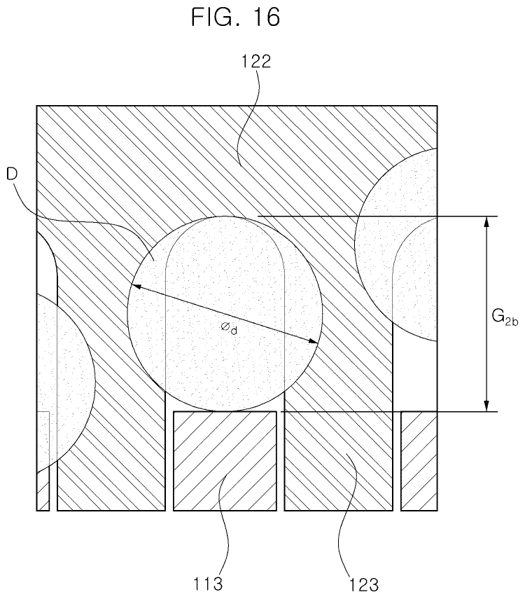

For this result, the oscillation of the droplet attenuates and a burnout does not occur in a condition in which the droplet does not come into contact with the first branch electrode 113. For this reason, as illustrated in FIG. 16, the spacing interval G_{2b} needs to be equal to or larger than the diameter Φ_{d} of the droplet D.

Table 1 below shows the radii of the droplets with respect to the volumes of the droplets.

TABLE 1

| Water | | | Calculated | Actually | | Expected |
|---|---|---|---|---|---|---|
| droplet | Contact | Calculated | contact | measured | Expected | contact |
| volume | angle | radius | radius | radius | radius | radius |
| μl | deg. | mm | mm | mm | mm | mm |
| 5 | 115 | 1.144 | 1.036 | 1.185 | — | 1.074 |
| | 75 | 1.567 | 1.514 | — | 1.624 | 1.568 |
| | 180 | 1.061 | — | — | | — |
| 4.2 (Raindrop) | 115 | 1.079 | 0.978 | — | 1.126 | 1.021 |
| | 75 | 1.479 | 1.428 | — | 1.543 | 1.491 |
| | 180 | 1.001 | 0.874 | — | — | — |
| 3 | 115 | 0.965 | 1.277 | 0.995 | — | 0.902 |
| | 75 | 1.322 | — | — | 1.363 | 1.317 |
| | 180 | 0.895 | 0.606 | — | — | — |
| 1 | 115 | 0.669 | 0.885 | 0.660 | — | 0.598 |
| | 75 | 0.916 | — | — | 0.904 | 0.874 |
| | 180 | 0.620 | 0.354 | — | — | — |
| 0.2 | 115 | 0.391 | 0.518 | — | 0.363 | 0.329 |
| | 75 | 0.536 | — | — | 0.497 | 0.480 |
| | 180 | 0.363 | 0.244 | — | — | — |
| 0.065 (Drizzle) | 115 | 0.269 | 0.356 | — | 0.249 | 0.226 |
| | 75 | 0.368 | — | — | 0.342 | 0.330 |
| | 180 | 0.249 | 0.096 | — | — | — |
| 0.004 (Fog | 115 | 0.106 | 0.141 | — | 0.098 | 0.089 |
| particle) | 75 | 0.145 | — | — | 0.135 | 0.130 |
| | 180 | 0.098 | — | — | — | — |

More specifically, with reference to Table 1, on a surface having a contact angle of 115 degrees, a minimum volume of a droplet, which does not naturally slide, is 3 μl. In embodiments of the present disclosure, a range of a droplet to be removed is 0.2 μl to 3 μl.

With reference to Table 1, a range of the diameter Φ_{d} of the droplet is as follows: 0.658˜0.782 mm≤Φ_{d}≤1.748˜1.93 mm.

Because G_{2b}≥Φ_{d} needs to be satisfied, a result, such as G_{2b}≥1.93 mm, may be derived, and there is no maximum limit as long as the space is allowable.

As described above, there has been derived the condition of the interval between the first branch electrode 113 and the second basal pattern electrode 122 for preventing the stagnation of the droplet at the upper side.

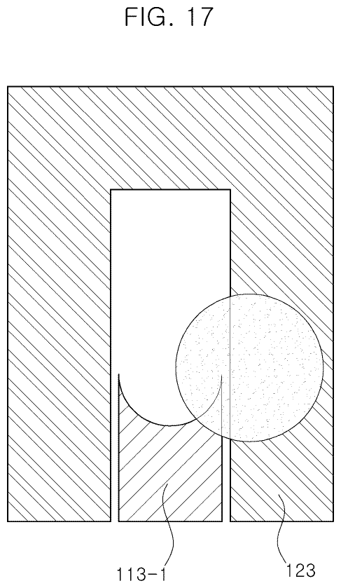

Further, as illustrated in FIGS. 17 to 19, the branch electrodes of embodiments of the present disclosure may have various shapes, thereby more easily preventing the stagnation of the droplet at the upper side.

The branch pattern in the above-mentioned embodiment has the upper end having a straight shape. Because of an angled shape of an edge, when the droplet reaches the edge of the upper end, the droplet may be restored to the upper end of the first branch electrode 113 or repeatedly moves while moving to a position at which there is a symmetric ratio between the first branch electrode 113 and the second branch electrode 123.

Therefore, embodiments of the present disclosure additionally propose an application example in which a shape of the upper end of the first branch electrode 113 is changed.

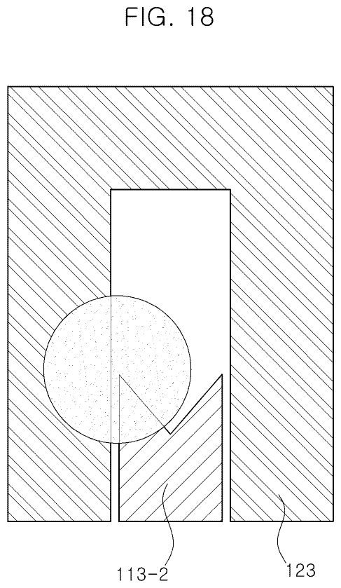

FIGS. 17 and 18 illustrate examples in which the upper ends of the first branch electrodes 113 each have a shape concavely formed downward, FIG. 17 illustrates an example in which the upper end of the first branch electrode 113 has a rounded shape, and FIG. 18 illustrates an example in which the upper end of the first branch electrode 113 has a pointy concave shape.

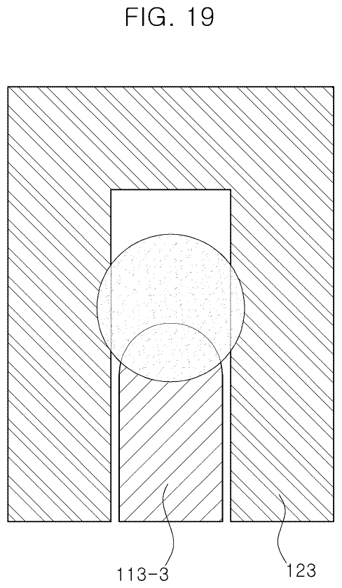

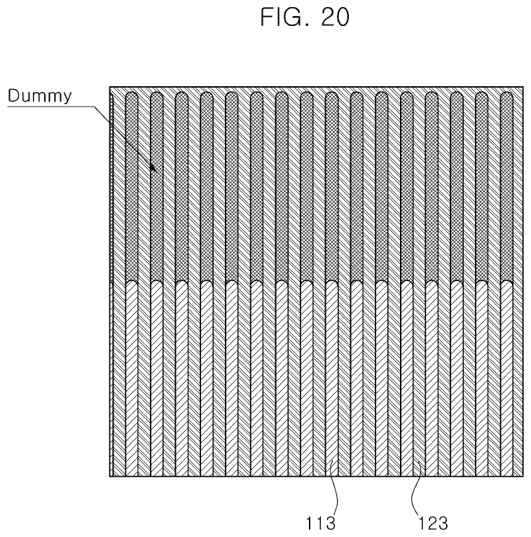

Further, FIG. 19 illustrates an example in which the upper end of the first branch electrode 113 has a shape formed convexly upward.

As described above, because of a difference in area in which the droplet D spans the first branch electrode 113 and the second branch electrode 123, the motion of the droplet may further increase in comparison with the shape in the related art.

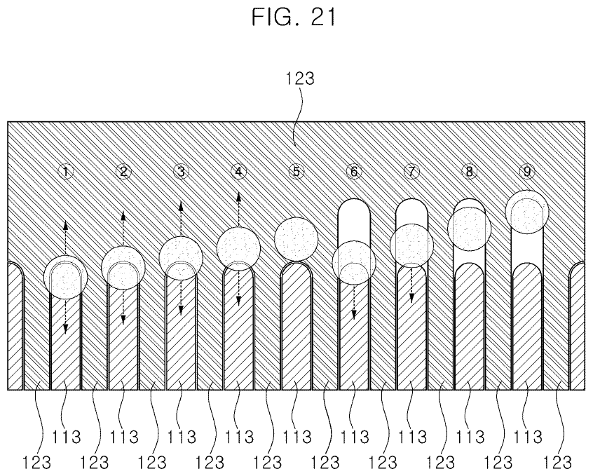

Next, FIG. 20 is a view illustrating an additional application example of the pattern electrode structure of embodiments of the present disclosure.

In embodiments of the present disclosure, an interval (gap) between the first branch electrode 113 and the second basal pattern electrode 122 in an upward direction is increased in comparison with the related art.

The gap space may be an empty space. However, the gap space may be a dummy pattern to which no voltage is applied. Because the dummy pattern may be electrically isolated, an effect identical to an effect obtained by a separation space may be implemented, and visibility may be compensated.

The influence of the above-mentioned interval between the second basal pattern electrode and the first branch electrode of the pattern electrode structure of embodiments of the present disclosure will be described below.

With reference to FIG. 21, in case that the droplet spans the two electrodes because the interval between the second basal pattern electrode 122 and the first branch electrode 113 is smaller than a size of the droplet, the droplets are placed as illustrated in the first to fourth cases, such that the droplets periodically receive downward and upward forces.

Therefore, the droplet cannot depart from a boundary portion, which causes a burnout of a surface dielectric layer.

In the case of the illustrated fifth case, because the droplet spans only the single electrode, a force applied to the droplet is low, and a burnout of the dielectric layer does not occur, but a frequency thereof is significantly low.

In contrast, in case that the interval between the second basal pattern electrode 122 and the first branch electrode 113 is designed to be equal to or larger than the size of the droplet, the droplet slides by receiving a downward force when the droplet spans the first branch electrode 113 like the illustrated sixth and seventh cases. In case that the droplet spans only the second basal pattern electrode 122 like the eighth and ninth cases, a force applied to the droplet decreases like the fifth case, such that a burnout of the dielectric layer does not occur.

While embodiments of the present disclosure have been described with reference to the exemplified drawings, it is obvious to those skilled in the art that the embodiments of the present disclosure are not limited to the aforementioned embodiments and may be variously changed and modified without departing from the spirit and the scope of the present disclosure. Accordingly, the changed or modified examples belong to the claims of the present disclosure, and the scope of the present disclosure should be interpreted on the basis of the appended claims.

What is claimed is:

1. A pattern electrode structure for an electrowetting device, the pattern electrode structure comprising:
a first branch electrode disposed in a direction perpendicular to any plane that is perpendicular to a plane defined by the pattern electrode structure; and
a basal pattern electrode disposed in an area above an upper end of the first branch electrode and connected to an electrode connection portion configured to receive a voltage, wherein an interval between the first branch electrode and the basal pattern electrode is equal to or larger than a diameter of a droplet to be removed.

2. The pattern electrode structure of claim 1, wherein the interval between the first branch electrode and the basal pattern electrode is equal to or larger than 1.93 mm.

3. The pattern electrode structure of claim 1, wherein a polarity of the first branch electrode is different from a polarity of the basal pattern electrode.

4. The pattern electrode structure of claim 3, further comprising second branch electrodes disposed alternately with a plurality of the first branch electrodes in a width direction of the pattern electrode structure, wherein a polarity of the second branch electrodes is different from the polarity of the first branch electrodes.

5. The pattern electrode structure of claim 1, further comprising second branch electrodes disposed alternately with a plurality of the first branch electrodes in a width direction of the pattern electrode structure, wherein a polarity of the second branch electrodes is different from the polarity of the first branch electrodes.

6. The pattern electrode structure of claim 1, wherein the upper end of the first branch electrode comprises a concave portion.

7. The pattern electrode structure of claim 1, wherein the upper end of the first branch electrode comprises a convex portion.

8. The pattern electrode structure of claim 1, wherein the upper end of the first branch electrode comprises a cutting-edge portion.

9. The pattern electrode structure of claim 1, further comprising a dummy pattern disposed in a space between the first branch electrode and the basal pattern electrode.

10. An electrowetting device comprising:
a base material;
a dielectric layer on the base material; and
an electrode layer laminated between the base material and the dielectric layer, the electrode layer comprising a pattern electrode structure comprising:
a first branch electrode disposed in a direction perpendicular to any plane that is perpendicular to a plane defined by the pattern electrode structure; and
a basal pattern electrode disposed in an area above an upper end of the first branch electrode and connected to an electrode connection portion configured to receive a voltage, wherein an interval between the first branch electrode and the basal pattern electrode is equal to or larger than a diameter of a droplet to be removed.

11. The electrowetting device of claim 10, wherein the interval between the first branch electrode and the basal pattern electrode is equal to or larger than 1.93 mm.

12. The electrowetting device of claim 10, wherein a polarity of the first branch electrode is different from a polarity of the basal pattern electrode.

13. The electrowetting device of claim 12, further comprising second branch electrodes disposed alternately with a plurality of the first branch electrodes in a width direction of the pattern electrode structure, wherein a polarity of the second branch electrodes is different from the polarity of the first branch electrodes.

14. The electrowetting device of claim 10, further comprising second branch electrodes disposed alternately with a plurality of the first branch electrodes in a width direction of the pattern electrode structure, wherein a polarity of the second branch electrodes is different from the polarity of the first branch electrodes.

15. The electrowetting device of claim 10, wherein the upper end of the first branch electrode comprises a concave portion.

16. The electrowetting device of claim 10, wherein the upper end of the first branch electrode comprises a convex portion.

17. The electrowetting device of claim 10, wherein the upper end of the first branch electrode comprises a cutting-edge portion.

18. The electrowetting device of claim 10, further comprising a dummy pattern disposed in a space between the first branch electrode and the basal pattern electrode.

19. A pattern electrode structure for an electrowetting device, the pattern electrode structure comprising:
a first electrode part comprising:
a first electrode connection portion;
a first basal pattern electrode connected to the first electrode connection portion; and
first branch electrodes branched off the first basal pattern electrode; and
a second electrode part comprising:
a second electrode connection portion;
a second basal pattern electrode connected to the second electrode connection portion; and
second branch electrodes branched off the second basal pattern electrode;
wherein the first electrode connection portion and the second electrode connection portion are connected to a power source to receive a voltage;
wherein the first branch electrodes and the second branch electrodes are arranged alternately in a width direction and are disposed in one direction that is perpendicular to any plane perpendicular to the pattern electrode structure; and
wherein an interval between the first branch electrodes and the second basal pattern electrode is equal to or larger than a diameter of a droplet to be removed.

20. The pattern electrode structure of claim 19, wherein upper ends of the first branch electrodes comprise a concave portion, a convex portion, or a cutting-edge portion.
